(19) United States
(12) Patent Application Publication
(10) Pub. No.: US 2026/0349278 A1
(43) Pub. Date: Nov. 5, 2026

(54) OPHTHALMIC LENS INCLUDING OPTICAL PRISMS AND A METHOD OF MANUFACTURING AN OPHTHALMIC LENS INCLUDING OPTICAL PRISMS

(71) Applicant: CooperVision International Limited, Fareham (GB)

(72) Inventors: Baskar ARUMUGAM, Dublin, CA (US); Arthur BRADLEY, Bloomington, IN (US); Sourav SAHA, San Ramon, CA (US)

(73) Assignee: CooperVision International Limited, Gareham (GB)

(21) Appl. No.: 19/663,352

(22) Filed: Apr. 30, 2026

Related U.S. Application Data
(60) Provisional application No. 63/798,632, filed on May 2, 2025.

(51) Int. Cl. G02C 7/04; G02C 7/14

(52) U.S. Cl. CPC G02C 7/044; G02C 7/14; G02C 2202/24

(57) ABSTRACT

An ophthalmic lens (10) comprises an optic zone (20; 320; 420; 520; 620; 720). The optic zone (20; 320; 420; 520; 620; 720) comprises at least one region having a base power for correcting distance vision. The optic zone (20; 320; 420; 520; 620; 720) also comprises a treatment zone. The treatment zone includes a plurality of optical prisms (49; 390; 490; 590; 690; 790) that have the base power. The plurality of optical prisms (49; 390; 490; 590; 690; 790) includes at least two optical prisms (49; 390; 490; 590; 690; 790) that differ from each other in prism power, prism angle or prism orientation. A method of manufacturing such an ophthalmic lens (10) is also described.

This application claims the benefit under 35 U.S.C. §119(e) of prior U.S. Provisional Patent Application No. 63/798,632, filed May 2, 2025, which is incorporated in its entirety by reference herein.

The present disclosure relates especially, but not exclusively to an ophthalmic lens including optical prisms. The present disclosure also relates to a method of making an ophthalmic lens, for example a spectacle lens, including optical prisms.

### BACKGROUND

Myopia onset and progression is on the rise worldwide. Every diopter increase in myopia increases the risk of developing retinal pathology including myopic macular degeneration and retinal detachment, which can lead to irreversible vision loss. The rising prevalence of myopia and other refractive errors has sparked significant research into optical interventions aimed at slowing the progression of these conditions.

Various ophthalmic lens designs have been proposed to alter the retinal image shell, manage peripheral defocus, or influence the accommodative-convergence system of the eye. Among these, lenses incorporating micro-optical structures have been developed to achieve specific optical functions conducive to therapeutic or corrective effects. Myopia control spectacle designs are known that include lenslets. ”DOT” myopia control spectacle lenses employ small regions (dots) of scatter optics. Myopia control lenses create a retinal image that is a combination of the image created by the distance-correction (base) optic and the blurred images created by the individual lenslets or scatter dots. CooperVision has a dual focus myopia control contact lens (MiSight 1 day) that is successful in slowing myopia progression and axial growth in children. The MiSight lens includes two annular treatment zones with +2D of added power that defocuses 40-50% of the light in the retinal image. Animal model studies show that adding plus power can slow eye growth in the presence of a myopiagenic environment.

Prism aberration is a geometrical image displacement that arises when light enters or exits a refracting surface at an angle, for example in prisms or in the periphery of spectacle lenses. Prism results in a lateral shift of the image. The image appears displaced or “kicked” to the side. Prism correction of interocular misalignment using decentered ophthalmic lenses is the clinical use of prism aberration.

WO 2013123558 A1 discloses an ophthalmic lens employing one or more prismatic components as the principal means for addressing myopia progression. The document describes the use of vertical and oblique prism orientations—such as base-down, base-in, or combined base-down-and-in configurations—to reduce extra-ocular muscle strain during near work. Such muscular relaxation is said to influence the biomechanical environment of the eye and thereby reduce axial elongation. The prisms may be incorporated centrally or in various regions of the lens with a view to achieving the desired physiological and optical effects.

EP 4390520 A1 discloses a spectacle lens comprising zones populated with micro-optical elements, which may be refractive, diffractive, or diffusive in nature. These elements are arranged to cover at least 30% of each zone’s area and are designed to produce specific modulation transfer function (MTF) profiles across spatial frequency ranges to maintain consistent visual acuity and facilitate control of myopic progression. The document lists prisms among various potential micro-optical element types; however, it does not provide any detailed teaching, embodiment, or claimed use involving prisms.

US 20230113340 A1 describes a spectacle lens incorporating compound microlens structures. Each compound microlens includes an on-axis microlenslet and one or more off-axis sub-lenslets, the latter of which may take the form of convex spheres, concave spheres, or prism shapes. These prism-shaped sub-lenslets are disclosed as part of the lens design to produce asymmetric light distribution and customized defocus profiles, and are intended to contribute to the management of hyperopic peripheral defocus, myopia progression, and associated visual disorders.

WO 2025032581 A1 discloses an adaptable thin lens platform comprising optical zones populated by customizable design elements. These elements may include concave, convex, plano, Fresnel-like, and free-form prism geometries. The lens system is configured to be attachable, printable, or integrable onto existing lenses, offering a modular solution for correcting a range of binocular vision problems such as anisometropia, aniseikonia, and diplopia. The use of free-form and Fresnel-type prism designs is disclosed as a mechanism for manipulation of visual alignment.

The present disclosure seeks to provide an improved ophthalmic lens for treating myopia progression.

### SUMMARY

According to a first aspect, the present disclosure provides an ophthalmic lens comprising an optic zone. The optic zone comprises at least one region having a base power for correcting distance vision. The optic zone also comprises a treatment zone and the treatment zone includes a plurality of optical prisms. The optical prisms have the base power. The plurality of optical prisms includes at least two optical prisms that differ from each other in prism power. Alternatively or additionally, the plurality of optical prisms includes at least two optical prisms that differ from each other in prism angle. Alternatively or additionally, the plurality of optical prisms includes at least two optical prisms that differ from each other in prism orientation.

According to a second aspect, the present disclosure provides a method of manufacturing an ophthalmic lens. The method includes the step of forming a first mould half and a second mould half. The method includes the step of providing a ophthalmic lens precursor material between the first mould half and the second mould half. The method includes the step of curing the precursor material to form a ophthalmic lens. At least one of the first mould half and the second mould half includes a region shaped to form an optic zone. The optic zone comprises at least one region, optionally a central zone, having a base power for correcting distance vision. The optic zone comprises a treatment zone, which if there is a central zone surrounds the central zone. The treatment zone includes a plurality of optical prisms. The optical prisms have the base power. The plurality of optical prisms includes at least two optical prisms that differ from each other in prism power. Alternatively or additionally, the plurality of optical prisms includes at least two optical prisms that differ from each other in prism angle. Alternatively or additionally, the plurality of optical prisms includes at least two optical prisms that differ from each other in prism orientation.

According to a third aspect, the present disclosure provides an ophthalmic lens having a lens body with a front surface and a back surface. The front surface meets the back surface at an edge. The front surface is otherwise separated from the back surface at every point in the lens body by a distance. The front surface has a first shape. The back surface has a second shape. The first shape and the second shape together define in the lens body a plurality of features. Said distance changes within each of the features such that the feature is an optical prism. Said change in distance with radius in at least one of the features is different from said change in distance with radius in at least one other of the features. The first shape and the second shape together define in the lens body a region of the lens body that is free from said features. In said region of the lens body said distance changes with radial distance, for example as for the surface of a sphere. Said distance defines the region to be a converging or diverging lens region for correcting the distance vision of a wearer’s eye.

According to a fourth aspect, the present disclosure provides an ophthalmic lens comprising an optic zone. The optic zone comprises a distance-vision region having a base power for correcting distance vision. The optic zone also comprises a treatment zone. The treatment zone includes a plurality of optical prisms. The optical prisms have the base power. The plurality of optical prisms includes at least two optical prisms that differ from each other in the angle at which they tilt relative to adjacent prism-free surface regions of the lens.

According to a fifth aspect, the present disclosure provides an ophthalmic lens comprising an optic zone. The optic zone comprises a distance-vision region having a base power for correcting distance vision. The optic zone also comprises a treatment zone. The treatment zone includes a plurality of optical elements. The optical elements have the base power. The optical elements displace images relative to, and in the focal plane of, images formed by the distance-vision region. The plurality of optical elements includes at least two optical elements that differ from each other in the distance that they displace the images.

According to a sixth aspect, the present disclosure provides an ophthalmic lens having a matrix region having a base power for correcting distance vision; and a plurality of optical elements that each has the base power and forms a diffraction-blurred micro-image displaced relative to and in the focal plane of a focal image formed by the matrix region, and wherein the plurality of optical elements includes at least two optical elements differing in the distance by which they displace their diffraction-blurred micro-images to form an aggregate blur patch from a plurality of diffraction-blurred images around the focal image formed by the matrix region.

According to a seventh aspect, the present disclosure provides an ophthalmic lens comprising an optic zone. The optic zone comprises a central zone having a base power for correcting distance vision. The optic zone also comprises a treatment zone surrounding the central zone and including a plurality of optical prisms. The optical prisms have the base power. The plurality of optical prisms includes at least two optical prisms that differ from each other in prism power. Alternatively or additionally, the plurality of optical prisms includes at least two optical prisms that differ from each other in prism angle. Alternatively or additionally, the plurality of optical prisms includes at least two optical prisms that differ from each other in prism orientation.

According to an eighth aspect, the present disclosure provides a method of making a spectacle lens, the method comprising: forming a lens blank having, on at least one surface, a surface profile comprising (i) at least one region having a base power for correcting distance vision and (ii) a treatment zone including a plurality of optical prisms. The optical prisms also have the base power. The plurality of optical prisms includes at least two optical prisms that differ from each other in prism power. Alternatively or additionally, the plurality of optical prisms includes at least two optical prisms that differ from each other in prism angle. Alternatively or additionally, the plurality of optical prisms includes at least two optical prisms that differ from each other in prism orientation.

It will of course be appreciated that features described in relation to one aspect of the present disclosure may be incorporated into other aspects of the present disclosure. For example, the method of the disclosure may incorporate features described with reference to the ophthalmic lens of the first aspect of the disclosure and vice versa.

### BRIEF DESCRIPTION OF THE DRAWINGS

Embodiments of the present disclosure will now be described by way of example only with reference to the accompanying schematic drawings, of which:

FIG. 1A is a front view of a contact lens.

FIG. 1B is a cross-section through a portion of a first lens according to an embodiment of the present disclosure.

FIG. 2 is (i) a schematic ray-tracing diagram for a lens having annular rings of curvature power, (ii) a schematic point spread function (PSF) corresponding to the base optic image plane of that lens, (iii) a schematic ray-tracing diagram for a second lens according to an embodiment of the present disclosure, having annular rings of optical prisms but no added curvature power, and (iv) a schematic PSF corresponding to the base optic plane of that lens.

FIG. 3 is a perspective view of the optic zone of a third example lens according to the present disclosure.

FIG. 4 is a perspective view of the optic zone of a fourth example lens according to the present disclosure.

FIG. 5 is a perspective view of the optic zone of a fifth example lens according to the present disclosure.

FIG. 6 is a perspective view of the optic zone of a sixth example lens according to the present disclosure.

FIG. 7 is a perspective view of the optic zone of a seventh example lens according to the present disclosure.

FIG. 8A is a schematic diagram showing locations of circular microprisms within a 5mm diameter region of a spectacle lens according to the present disclosure.

FIG. 8B is a schematic diagram showing the surface profile of a one of the microprisms of FIG. 8A.

FIG. 9 is a set of schematic diagrams showing (i) a combined primary focused image and a target blur size, (ii) a geometrical optics depiction of a combined primary and 12 individually displaced images from microprisms, and (iii) a wave optics depiction of a combined primary and 12 individually displaced images from microprisms, from the same optics as was used to create the geometric optics depiction of (ii).

FIG. 10 is (i) a wave-optics modelled point spread function of a spectacle lens according to the present disclosure and (ii) a wave-optics modelled extended image formed by that spectacle lens.

FIG. 11A is a plot of wavefront error as a function of position on a lens according to the present disclosure, for an array of prisms that are arranged to displace all rays radially, away from the centre of the lens.

FIG. 11B is a plot of wavefront error as a function of position on a lens according to the present disclosure, for an array of prisms that are arranged to displace rays at random deviation angles.

FIG. 12 is a flow chart showing an example method of manufacturing lenses according to an embodiment of the present disclosure.

### DETAILED DESCRIPTION

As used herein, the following terms have the following meanings:
Base power: the term “base power” refers to a sphere power, i.e. a focusing or defocusing power, of an ophthalmic lens. The base power is typically a power chosen to provide distance vision, i.e. it is typically a power chosen to focus distance targets at or near to the patient’s retina.
Contact lens: the term “contact lens” refers to an ophthalmic lens that can be placed onto the anterior surface of the eye. It will be appreciated that such a contact lens will provide clinically acceptable on-eye movement and not bind to the eye or eyes of a person.
Focal plane: the term “focal plane” does not refer to a physical surface, but to a surface that could be drawn through points where light from distant objects would be focused. Such a surface is also referred to as a “focal surface”, an “image plane” or an “image shell”. The eye focuses light onto the retina, which is curved, and in a perfectly focused eye, the curvature of the image shell would match the curvature of the retina. Therefore, the eye does not focus light onto a flat mathematical plane. However, in the art, the curved surface of the retina and other focal surface in the eye are commonly referred to as planes.
Length: the length of a prism is its longest dimension in a direction parallel to the surface of the lens.
Matrix region: a prism-free base-power region of an ophthalmic lens.
Optic zone”: the term optic zone” refers to the part of an ophthalmic lens that has optical functionality. In contact lenses, the optic zone is configured to be positioned over the pupil of an eye when in use. In spectacle lenses, the optic zone is all parts of the lens through which the wearer looks in normal use, which may be the whole of the lens.
Optical path length: the term “optical path length” is the length of the physical path that light takes through an optical element multiplied by the refractive index of the material of the optical element through which the light passes. For an optical element of uniform refractive index, the optical path length will be proportional to the physical path length.
Optical prism: the term an “optical prism” in general optics refers to an optical element that provides a linear increase or decrease in optical path length with distance across the element. However, as simple ophthalmic lenses already provide optical path lengths that change with position on the lens (in order to focus incident light), the term “optical prism” as used herein refers to a portion of the ophthalmic lens that has the curvature of the base power of the lens but which provides to incident light an additional optical path length that increases or decreases linearly with distance across the lens. Thus, the effect of the optical prism will be to uniformly deflect optical rays that pass through it, so that an image formed by the rays is displaced laterally compared with a corresponding image formed by an otherwise identical lens that does not include the optical prism. The deflected ray bundles will not change their focal plane (i.e. the image is focused at the same distance from the retina), but the resulting images will be shifted laterally within that plane. Because the lens will have an underlying curvature, unlike a conventional prism the refracting surface of the optical prism will not be physically flat; rather it will include the surface curvature that provides the distance correction. The difference between the optical path length through the optical prism and the optical path length through an otherwise identical lens portion without the optical prism will increase linearly with distance across the lens.
Peripheral zone: the term “peripheral zone” refers to a part of a contact lens that is not part of the optic zone, but sits outside the optic zone and above the iris when the lens is worn, and it provides mechanical functions, for example, increasing the size of the lens thereby making the lens easier to handle, providing ballasting to prevent rotation of the lens, and/or providing a shaped region that improves comfort for the lens wearer. The peripheral zone may extend to the edge of the contact lens.
Prism angle: the term “prism angle” refers to the structural tilt introduced into the surface of the ophthalmic lens by the presence of the optical prism. It is the magnitude of the change, compared with an identical ophthalmic lens without the optical prism, in the angle of a tangent to the refracting surface of the optical prism extending in a direction orthogonal to the join between the optical prism and the surrounding, undisplaced surface. If the optical prism is present on both the anterior and the posterior surfaces of the ophthalmic lens then the prism angle is the sum of the changes on each surface. In practice, the junction between the prism and the surface of the lens surrounding the prism may be blended, i.e. smoothed or rounded, in order not to have sharp edges or sharp indentations that could cause irritation or infection.
Prism orientation: the term “prism orientation” refers to the direction in which the prism is facing on the surface of the ophthalmic lens. For example, a prism may be oriented with its tilted face sloping towards the centre of the lens, or away from the centre of the lens, or towards the leftmost part of the lens or towards the rightmost part of the lens or at some other angle Although defined in angular terms, the prism orientation is distinct from the “prism angle” defined above. The prism angle defines the prism tilt relative to the base surface whereas the prism orientation defines the angle of the prism relative to a radial line on the surface of the lens axis to the prism.
Prism power: the term “prism power” refers to the size of the lateral shift in image position caused by the optical prism, i.e. the ray deviation introduced by the prism. For clinical convenience, eye care practitioners define these angles in 1/100 of a radian, and the unit is named a “prism diopter”. By definition: a 1 prism diopter will displace an image by 1 cm at a distance of 1 meter. The prism power is proportional to the prism angle for small prism angles.
Tilt: the tilt of a prism is the smallest angle through which refractive surface of the prism must be rotated, back towards the surface of the lens surrounding the prism, for it to have zero prism power, i.e. it is equal to the prism angle.
Width: the width of a prism is its shortest dimension in a direction parallel to the surface of the lens and perpendicular to the length of the prism.

The present disclosure provides an ophthalmic lens comprising an optic zone, the optic zone comprising: (i) at least one region having a base power for correcting distance vision; and (ii) a treatment zone including a plurality of optical prisms, wherein the plurality of optical prisms have the base power and include at least two optical prisms that differ from each other in prism power, angle or orientation.

It will be appreciated that this aspect of the disclosure may optionally be combined with any features described below in respect of this or another aspect of this disclosure.

Thus a plurality of microprisms is provided in an ophthalmic lens, for example a contact lens or a spectacle lens, each of which creates its own focused image. The resulting composite image at the base optic focal plane combines a focused primary image (from the at least one base power region) containing the majority of the light, with multiple individually displaced focused images (from the plurality of optical prisms) each containing a small amount of light. Optionally, each micro-prism is small enough to create significant diffraction blur. The total amount of light within the aggregate image is then a combination of a single focused primary image and the plurality of prismatically displaced diffraction blur patches.

Composite images created by superimposing multiple focused images each displaced laterally can lower image contrast. Unlike prior art approaches, in which image contrast is lowered by individual elements that either defocus light or scatter light, lenses according to the present disclosure control image contrast by combining the core correction optic (distance) image with multiple other focused and displaced images due to microprisms.

The optical prisms of the present disclosure share a focal plane with the base optic whereas, in prior art approaches that employ focusing elements, those focusing elements have focal planes that are axially separated from the base optic. The ophthalmic lens of the present disclosure aims to create multiple small image shifts without added converging or diverging power; rather, local tilts are included into the base optic effectively adding a local prism aberration to areas of the lens. Thus, the optical prisms have the base power. The images are formed on the same focal plane as the image focused by the (other) region or regions having the base power. However, the optical prisms produce images that are shifted laterally relative to the image produced by the region or regions having the base power. Thus, the optical prisms form focused but displaced images of distant objects. The resulting overlapping images may be individually sharply focused but collectively exhibit some characteristics of image blur and contrast reduction, which the inventors expect to result in control of myopia progression in a wearer of the lens

The size of the shift in image location provided by the optical prism will increase with increasing prism angle, approximately linearly for small prism angles. The direction of the shift in image location will vary with the orientation of the optical prism. (In general for a prism in air, the angular ray deviation is equal to the prism angle times the difference between the refractive index of the material of the prism and the refractive index of the material surrounding the prism.)

In terms of foci, whilst the approximation of geometric optics (which treats light as a bundle of rays) suggests that a focus is a point, the better approximation of physical optics (which treats light as a wave) shows that the best-focused image of a point is a (structured) blur known as the Airy disc. This blur results from diffraction, and occurs without the need for defocus (i.e. it occurs at the geometric ray focus).

As stated above, the tilt magnitude (i.e. the prism angle, relative to the base optic) will determine how far from the base optic image the deviated image will be located. Considering an array of such prisms, tilt magnitude may be used to regulate the size of the resulting aggregate blur patch. The path taken by any individual prism-deviated ray bundle will also be controlled by the angle of the tilt. The at least two optical prisms may differ from each other in prism power, angle or orientation by an amount that varies randomly, pseudo-randomly, or in an otherwise disorganised manner across the lens. It is expected that such variations will approximately stabilize the blur pattern as the eye gaze angle changes and different small regions of a spectacle lens are used to create the foveal image. Similarly, peripheral retinal images will be created by different regions of a spectacle lens, and again such variations may be desirable to approximately stabilize the aggregate blur patch.

Rays passing through at least one of the prisms may be skew rays, that is, they may be rays that never intersect with the optical axis of the lens. It may be that all rays passing through at least one of the prisms are skew rays. If a prism deviates a local region of the surface along a radial direction, either towards or away from the lens centre, rays passing through the prism will cross the optic axis. However, for an eye fitted with spectacle lenses, there is not a simple optical axis. Rather, local clusters of prisms may be directed toward or away from the local “chief ray” (the ray that will pass through the centre of the pupil of the eye). However, because the chief ray will change with gaze direction, there is no fixed chief ray. Providing a random or otherwise irregular or disordered arrangement of prisms can allow for those variations in gaze directions. If rays are deviated in random, irregular or disordered directions, the deviated ray bundles may never arrive at and cross the axis (local chief ray), and such rays are classically called “skew rays”.

The power of the plurality of optical prisms may be the same as the base power to the nearest 0.25D.

The plurality of optical prisms may include at least two (for example at least 3, at least 5 or at least 10) optical prisms that differ from each other in prism power and angle and not in orientation. The plurality of optical prisms may include at least two (for example at least 3, at least 5 or at least 10) optical prisms that differ from each other in orientation and not in prism power and prism angle. The plurality of optical prisms may include at least two (for example at least 3, at least 5 or at least 10) optical prisms that differ from each other in prism power, angle and orientation.

All the optical prisms may differ from each other in prism power and angle and not in orientation. All the optical prisms may differ from each other in orientation and not in prism power and angle. All the optical prisms may differ from each other in prism power, angle and orientation.

At least some, optionally all, of the optical prisms may be protrusions from the surface of the lens. At least some, optionally all, of the optical prisms may be indentations in the surface of the lens.

The prism angle may be small. It may be, for example, less than 10 degrees, less than 5 degrees, less than 3 degrees, less than 1 degree, less than 0.5 degrees or less than 0.3 degrees. The prism angle may be, for example, more than 0.01 degree, more than 0.05 degrees, more than 0.1 degree, more than 0.5 degrees, more than 0.8 degrees or more than 1 degree.

The prism angle may become progressively smaller for prisms that are progressively closer to the centre of the lens. The prism angle may become progressively larger for prisms that are progressively further from the centre of the lens.

The ophthalmic lens may be a spectacle lens. The ophthalmic lens may be a contact lens. The contact lens may be a corneal lens (e.g., a lens that rests on the cornea of the eye).

The ophthalmic lens may further comprise a peripheral zone surrounding the optic zone. The peripheral zone does not provide an optical function but rather provides mechanical functions, for example increasing the size of the lens so that it can be handled more easily than if the lens did not extend beyond the optic zone.

The optic zone may be circular. The optic zone may be sized so that it covers, or approximately covers, the human pupil in all lighting conditions, for example, in a contact lens, it may have a diameter of between 6 mm and 8 mm. In a finished spectacle lens the optic zone may have a maximum transverse dimension of, for example, between 25 mm and 60 mm. The optic zone has an optical axis, which may be at the centre of the optic zone (for example in a contact lens).

The plurality of optical prisms may include at least two optical prisms that differ from each other in radial width.

The optical prisms can have any orientation within the optic zone.

The optical prisms may vary, in power, angle or orientation, periodically with azimuthal position in the lens.

The optical prisms will be formed by a local tilt of the anterior surface of the ophthalmic lens, the posterior surface of the ophthalmic lens, or both surfaces of the ophthalmic lens. The tilted surface may return to a base level to form an approximate right-angle (i.e. it may return steeply) or it may return more gradually. The local tilt may be a radial tilt, i.e. a tilt along a direction outward from or towards the centre of the lens. At least one of the optical prisms may have a thickness that increases with increasing radius, that is it may be base-out relative to the centre of the lens.

The optic zone may include a central zone having the base power. The central zone may be free of prisms. The treatment zone may surround the central zone. The central zone and the treatment zone and the peripheral zone (if present) may be concentric with the optical axis.

The treatment zone may have an inner border that is contiguous with an outer border of the central zone. The treatment zone may have an outer border that is contiguous with an inner border of the peripheral zone (if present).

The treatment zone may include at least one treatment region that contains a plurality of the optical prisms and surrounds the central zone. The treatment zone may include at least one base-power region that has the base power and surrounds the treatment region. The treatment zone may further comprise at least one further treatment region surrounding the base-power region. The further treatment region or regions may include a plurality of optical prisms. The treatment region, the base-power region, any further treatment region and any further base power region may be concentric.

A zone or region of the lens that has the base power may be free from optical prisms. All zones or regions of the lens that have the base power may be free from optical prisms.

The treatment region or regions may be annular.

The plurality of optical prisms may form a plurality of rings. The rings may be grouped so that rings within each group are closer to their nearest neighbour in the group than to any of the plurality of rings that are not in the group. There may be at least 3 rings in each group. There may be at least 5 rings in each group. There may be at least 7 rings in each group.

At least one of the rings may be a circular disc. All the rings may be circular rings. At least one of the optical prisms may be annular. The annular prism may be oriented with its tilted face towards the centre of the lens. The annular prism may be oriented with its tilted face away from the centre of the lens. At least one of the rings may be a discontinuous circle, formed from two or more of the optical prisms each separated from the other. At least one of the optical prisms may be a segment of an annulus. At least one of the rings may be arcuate.

At least one of the optical prisms may be a cylinder, that is, it may have the same size and shape in all cross-sections orthogonal to its length. At least one of the optical prisms may be a right cylinder, that is, it may be a cylinder having a side (that is, a face) parallel to its length that forms a 90 degree angle with the surface of the lens surrounding the prism.

At least one of the optical prisms may be disc-shaped. At least one of the optical prisms may be circular, that is, it may have the same, or substantially the same, transverse dimension in all directions in the plane of the lens, so that it has the shape of a disc when viewed from the front of the lens. The circular prisms may each focus light to an Airy disc. The circular prisms may reduce contrast by displacing the focal Airy discs such that they overlap with each other (and with the un-displaced Airy disc resulting from prism-free regions of the lens that have the base power). The size of an Airy disc from a circular prism depends on the size of the prism: the smaller the prism, the larger the disc, as it is a diffractive effect. The (i) size and (ii) position of the Airy disc are controlled by the (i) size and (ii) angle and orientation of the prism, respectively. The Airy disc resulting from prism-free regions of the lens having the base power can be expected to be smaller than the Airy disc resulting from any of the circular prisms, as the prism-free region having the base power will generally be larger than any of the circular prisms.

At least one of the rings may be polygonal, that is the ring may have the shape of a polygon rather than a circle. All the rings may be polygonal. Each optical prism within the polygonal ring may be a cylindrical prism forming a side (that is, an edge) of the polygon. Each optical prism within the polygonal ring may join with a neighbouring optical prism within the polygonal ring so that the polygonal ring is continuous. At least one of the rings may be a discontinuous polygon, formed from two or more of the optical prisms each separated from the other. The number of vertices in the polygons may be different for each polygon.

At least one of the rings may have the shape of a curvilinear polygon. All the rings may be curvilinear polygons. Each optical prism within the curvilinear polygonal ring may join with a neighbouring optical prism within the curvilinear polygonal ring so that the curvilinear polygonal ring is continuous. At least one of the rings may be a discontinuous curvilinear polygon, formed from two or more of the optical prisms each separated from the other. The number of vertices in the curvilinear polygons may be different for each curvilinear polygon.

Each optical prism may be orthogonal to a radius of the central zone, that is, the longitudinal axis of the prism may be orthogonal to a radius of the central zone.

Each of the optical prisms may have a maximum width of for example more than 0.1 mm, more than 0.3 mm, more than 0.5 mm or more than 0.9 mm. Each of the optical prisms may have a maximum width of for example less than 2 mm, less than 1.7 mm, less than 1.5 mm, less than 1.3 mm, less than 1.1 mm, less than 1.0 mm or less than 0.8 mm. Each of the optical prisms may have a length of for example more than 0.2 mm, more than 0.5 mm, more than 0.75 mm, more than 1 mm, more than 1.5 mm, more than 2 mm or more than 3 mm. Each of the optical prisms may have a length of for example less than 5 mm, less than 4 mm, less than 3 mm,less than 2 mm, less than 1 mm, or less than 0.8 mm. For example, each of the optical prisms may be about 1 mm wide and about 2 mm long. When the optical prisms form complete rings, the length of each prism will of course be determined by the radius of the ring and, for polygonal rings, the number of sides (i.e. edges). Diffraction effects become more significant as the prism becomes smaller, thus, the prism may have a maximum transverse dimension of less than 1 mm, less than 0.6 mm, or less than 4 mm, for example about 0.5 mm or about 0.25 mm.

The optical prisms may be positioned irregularly within the optic zone outside the central zone, if present. It may be that no two optical prisms have the same prism base length, base width and prism angle.

The lens may comprise at least 3, at least 10, at least 40 or at least 50 optical prisms. The optical prisms may be arranged to superimpose at least 3 offset images on each other. The optical prisms may be arranged to superimpose at least 10 offset images on each other. The optical prisms may be arranged to superimpose at least 40 offset images on each other. The optical prisms may be arranged to superimpose at least 50 offset images on each other. The point spread functions of each optical prism are in different locations and overlap to form a blur patch that is larger than the individual point spread functions.

The amount of light within each offset image will be proportional to the area of the optical prism that offsets the image. The proportion of the total light in the composite image contributed by each offset image will be determined by the proportion of the pupil area or optic zone covered by the prism. Each individual offset image will typically have little light in it, but the total light in all the offset images will be significant. Thus, the optical prisms may cover for example more than 10%, more than 20%, more than 40% or more than 50% of the area of the optic zone. The optical prisms may cover for example less than 70%, less than 50% or less than 30% of the optic zone. For example, the optical prisms may cover 10% to 70%, for example 20% to 60% of the optic zone. The contrast of the distance image formed by the central zone will be approximately proportional to the proportion of light not passing through the optical prisms. For example, if the optical prisms cover 40% of the optic zone, the image contrast will be approximately 60%.

The number of prisms per unit area may decrease from an outer edge of the treatment region to the centre of the lens or to an inner edge of the treatment region. It may be that the number of prisms per unit area is lower in a more inward region of the treatment region and higher in a surrounding, more outward region of the treatment region. Said regions may be nested annuli.

The tilt of the prisms may increase or decrease from an outer edge of the treatment region to the centre of the lens or to an inner edge of the treatment region. It may be that the average tilt of prisms in a more inward region of the treatment region is lower than the average tilt of prisms in a surrounding, more outward region of the treatment region. Said regions may be nested annuli.

A contact lens according to the present disclosure may comprise, consist essentially of, or consist of any one of the following: an elastomer material, a silicone elastomer material, a hydrogel material, or a silicone hydrogel material. A contact lens according to the present disclosure may comprise an elastomer material, a silicone elastomer material, a hydrogel material, or a silicone hydrogel material or combinations thereof. As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, nelfilcon A, hilafilcon A, lehfilcon A, galyfilcon A, and the like.

The contact lens may have a body of a softer contact lens material and the optical prisms may be of a harder contact lens material. Thus, the contact lens may have a body formed of a material and the optical prisms may be formed of a material that is harder than the material forming the contact lens body. The optical prisms may be inserts, which may be inserted into the contact lens body.

By way of example, the lens may comprise a hydrogel or silicone hydrogel contact lens having a lens diameter of between 13 and 15 mm. The optic zone of the lens may have a diameter of between 7 and 9 mm.

The lens can be formed by a moulding process (for example an injection moulding process, a cast moulding process or a spin cast molding process), or a lathing process, or a combination thereof. The optical prisms may be formed by, for example, etching or laser ablating a mould used to form the lens. As understood by persons skilled in the art, cast moulding refers to the moulding of a lens by placing a lens forming material between a female mould member having a concave lens member forming surface, and a male mould member having a convex lens member forming surface.

The present disclosure also provides a method of manufacturing an ophthalmic lens, the method including the steps: (a) forming a first mould half and a second mould half; (b) providing a lens precursor material between the first mould half and the second mould half; and (c) curing the precursor material to form an ophthalmic lens; wherein at least one of the first mould half and the second mould half includes a region shaped to form an optic zone, the optic zone comprising: (i) at least one region having a base power for correcting distance vision; and (ii) a treatment zone including a plurality of optical prisms, wherein the plurality of optical prisms have the base power and include at least two optical prisms that differ from each other in power, angle or orientation.

It will be appreciated that this aspect of the disclosure may optionally be combined with any features described above or below in respect of this or another aspect of this disclosure.

The optic zone may include a central zone having the base power. The central zone may be free of prisms. The treatment zone may surround the central zone.

The ophthalmic lens may be a contact lens. The method may include the further step of hydrating the contact lens. The method may include the further step of packaging the contact lens.

The present disclosure also provides an ophthalmic lens having a lens body with a front surface and a back surface, the front surface meeting the back surface at an edge but otherwise being separated from the back surface at every point in the lens body by a distance, the front surface having a first shape and the back surface having a second shape, the first shape and the second shape together defining in the lens body: (i) a plurality of features, wherein said distance changes within each of the features such that the feature is an optical prism, wherein said change in distance in at least one of the features is different from said change in distance in at least one other of the features; and (ii) a region (optionally a central region) of the lens body that is free from said features and wherein said distance changes with radial distance such that the (optionally central) region is a converging or diverging lens region for correcting the distance vision of a wearer’s eye.

It will be appreciated that this aspect of the disclosure may optionally be combined with any features described above or below in respect of this or another aspect of this disclosure.

The change in the distance in at least one of the features may be a substantially linear change in the distance. The change in the distance in at least one of the features may be a change with radial distance (that is, in a radial direction from the central axis of the lens).

The present disclosure also provides an ophthalmic lens comprising an optic zone, the optic zone comprising: (i) a distance vision region having a base power for correcting distance vision; and (ii) a treatment zone including a plurality of optical prisms having the base power, wherein the plurality of optical prisms includes at least two optical prisms that differ from each other in the angle at which they tilt relative to adjacent prism-free surface regions of the lens.

It will be appreciated that this aspect of the disclosure may optionally be combined with any features described above or below in respect of this or another aspect of this disclosure.

The present disclosure also provides an ophthalmic lens comprising an optic zone, the optic zone comprising: (i) a central zone having a base power for correcting distance vision; and (ii) a treatment zone surrounding the central zone and including a plurality of optical prisms having the base power, wherein the plurality of optical prisms includes at least two optical prisms that differ from each other in the angle at which they tilt relative to adjacent prism-free surface regions of the lens.

It will be appreciated that this aspect of the disclosure may optionally be combined with any features described above or below in respect of this or another aspect of this disclosure.

The present disclosure also provides an ophthalmic lens comprising an optic zone, the optic zone comprising: (i) a distance-vision region having a base power for correcting distance vision; and (ii) a treatment zone including a plurality of optical elements that have the base power but displace images relative to, and in the focal plane of, images formed by the distance vision region, wherein the plurality of optical elements includes at least two optical elements that differ from each other in the distance that they displace the images.

It will be appreciated that this aspect of the disclosure may optionally be combined with any features described above or below in respect of this or another aspect of this disclosure.

The present disclosure also provides an ophthalmic lens comprising an optic zone, the optic zone comprising: (i) a central zone having a base power for correcting distance vision; and (ii) a treatment zone surrounding the central zone and including a plurality of optical elements that have the base power but displace images relative to, and in the focal plane of, images formed by the central zone, wherein the plurality of optical elements includes at least two optical elements that differ from each other in the distance that they displace the images.

It will be appreciated that this aspect of the disclosure may optionally be combined with any features described above or below in respect of this or another aspect of this disclosure.

The present disclosure also provides an ophthalmic lens package including an ophthalmic lens according to an aspect of the present disclosure and including a label indicating the base power of the lens.

It will be appreciated that this aspect of the disclosure may optionally be combined with any features described above or below in respect of this or another aspect of this disclosure.

The label may indicate a prism power of the lens.

The ophthalmic lens may be a contact lens and the package may include a blister containing the lens and a storage solution. The label may be on the blister. The package may be a carton including a plurality of the blisters. The label may be on the carton.

The present disclosure also provides a method of making a spectacle lens, the method comprising: forming a lens blank having, on at least one surface, a surface profile comprising (i) at least one region having a base power for correcting distance vision and (ii) a treatment zone including a plurality of optical prisms, the optical prisms having the base power, wherein the plurality of optical prisms includes at least two optical prisms that differ from each other in prism power, prism angle or prism orientation.

It will be appreciated that this aspect of the disclosure may optionally be combined with any features described above or below in respect of this or another aspect of this disclosure.

The lens blank may be formed from a glass or an organic polymer material.

The surface profile may be formed by moulding the lens blank such that the at least one lens surface is formed with said surface profile.

The surface profile may be formed by machining the at least one lens surface of the lens blank. Machining the at least one lens surface may comprise one or more of computer-controlled machining, freeform machining, laser engraving, diamond turning, grinding, and polishing.

The surface profile may be formed by applying a coating composition to the at least one lens surface and shaping the coating composition before curing. Shaping the coating composition may comprise stamping the coating composition.

The organic polymer material may be a thermosetting resin or a thermoplastic resin.

Forming the lens blank may comprises casting a curable liquid composition into a mould cavity and polymerising and curing the curable liquid composition to form the lens blank. The mould cavity may define at least part of said surface profile.

The lens blank may be a finished stock lens or a semi-finished lens blank.

The spectacle lens may be subjected to one or more finishing operations, for example coating, edging, and/or mounting.

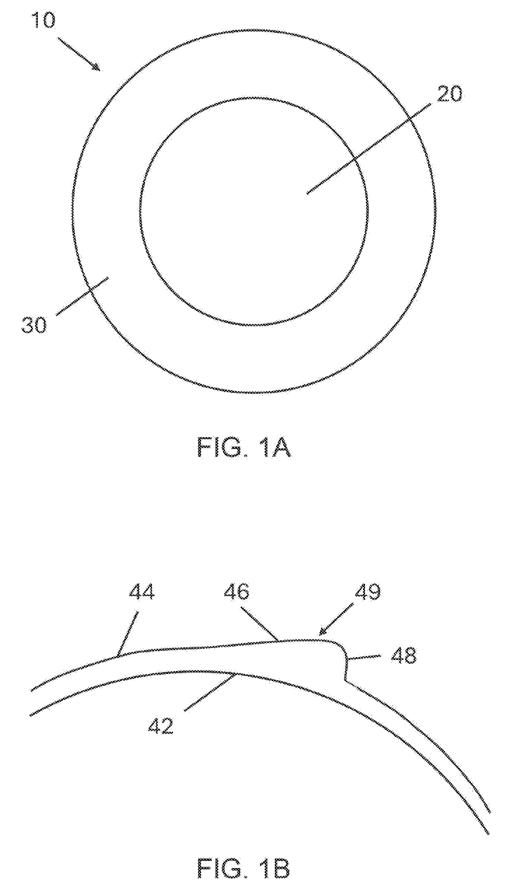

An ophthalmic lens in the form of a contact lens 10 (FIG. 1A) includes an optic zone 20 and a peripheral zone 30. The peripheral zone 30 is annular and surrounds the optic zone 20.

Lenses according to embodiments of the present disclosure include optical prisms. A first example of a lens including an optical prism (shown schematically in FIG. 1B) has a posterior surface 42 and an anterior surface 44. In a first region 46 of the lens, the distance between the posterior surface 42 and the anterior surface 44 of the lens increases substantially linearly with radial distance from the optical axis. The distance between the posterior surface 42 and the anterior surface 44 then decreases again, with still further increasing radius, forming a relatively sharply curved second region 48, radially adjacent to the first region 46. The substantially linear region 46 and the sharply curved region 48 together form an optical prism 49.

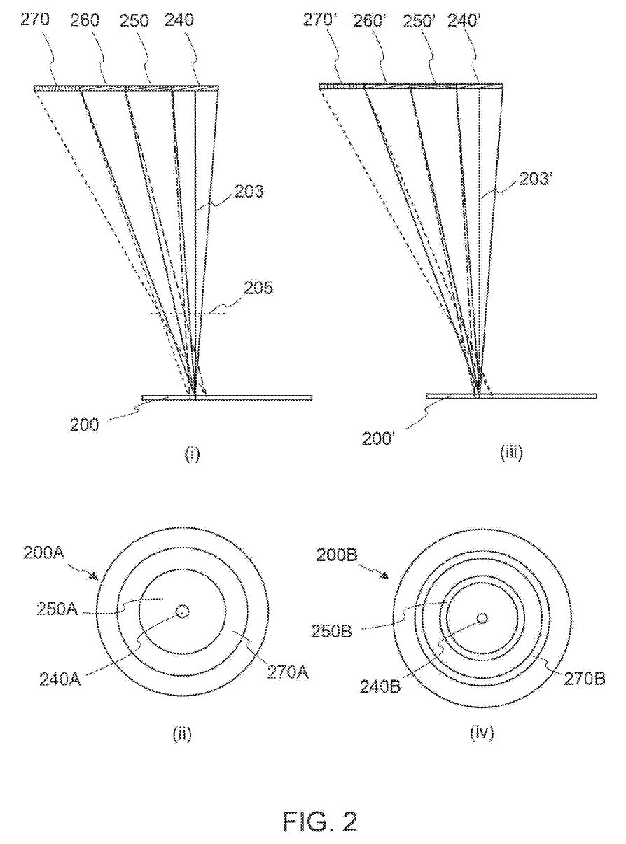

A conventional myopia control lens (FIG. 2(i) and 2(ii)) includes a central zone 240 having a base power for correcting distance vision. The central zone 240 focuses light from an on-axis source (not shown) onto the optical axis 203 of the lens. The central zone 240 is surrounded by a first annular zone 250 having an add power relative to the base power. The first annular zone 250 is also radially tilted, relative to the curve of the central zone 240, so that it does not focus light onto the optical axis 203. The first annular zone 250 is surrounded by a second annular zone 260. The second annular zone 260 has the base power and focuses light onto the optical axis 203. The second annular zone 260 is surrounded by a third annular zone 270. The third annular zone 270 has an add power and is tilted so that it does not focus light onto the optical axis 203.

This lens has circular symmetry, so that the zones 240, 250, 260 and 270 and the rays shown in FIG. 2 are the same for all meridians.

The central zone 240 and the second annular zone 260 both focus incident light that is parallel to the optic axis of the lens to a base power focal plane 200. The first annular zone 250 and the third annular zone 270 both focus incident parallel light to an add power focal plane 205. Light, from a distance on-axis point, passing through the lens results in a point spread function (PSF) 200A at the base power focal plane 200. The PSF 200A includes a central focal spot 240A, formed by the light passing through the central zone 240 and the second annular zone 260, and two discs 250A, 270A of defocused light, formed by the light passing through the first annular zone 250 and the third annular zone 270.

A second example myopia control lens according to the present disclosure (FIG. 2(iii) and 2(iv)) includes a central zone 240’ having a base power for correcting distance vision. The central zone 240’ focuses light from an on-axis source (not shown) onto the optical axis 203’ of the lens. The central zone 240’ is surrounded by a first annular zone 250’ also having the base power. The first annular zone 250’ is radially tilted, relative to the curve of the central zone 240’, so that it does not focus light onto the optical axis 203’. The first annular zone 250’ is surrounded by a second annular zone 260’. The second annular zone 260’ has the base power and focuses light onto the optical axis 203’. The second annular zone 260’ is surrounded by a third annular zone 270’. The third annular zone 270’ has the base power and is tilted so that it does not focus light onto the optical axis 203’.

This lens has circular symmetry, so that the zones 240’, 250’, 260’ and 270’ and the rays shown in FIG. 2 are the same for all meridians. Thus the zones 250’and 270’ each form an annular prism.

The central zone 240’, the first annular zone 250’, the second annular zone 260’ and the third annular zone 270’ all have the same power and so they all focus incident parallel light to a base power focal plane 200’. Light, from a distant on-axis point, passing through the lens results in a point spread function 200B at the base power focal plane 200’. The PSF 200B includes a central focal spot 240B, formed by the light passing through the central zone 240’ and the second annular zone 260’, and two rings 250B, 270B of focused light, formed by the light passing through the first annular zone 250’ and the third annular zone 270’. The first annular zone 250’ and the third annular zone 270’ having tilt without add power means that those zones have optical prism, which results in ray bundles that deviate laterally to create laterally displaced images in the base power focal plane 200’.

The presence of the optical prisms results in image blur, caused by the combining of the multiple in focus but spatially off-set images created by the prismatic first annular zone 250’ and third annular zone 270’. The inventors hypothesise that the location of the focal planes of light from lenslets is not a key feature of their myopia control properties, but rather it is the multiple images that in combination produce blur analogous to blur being generated by defocus.

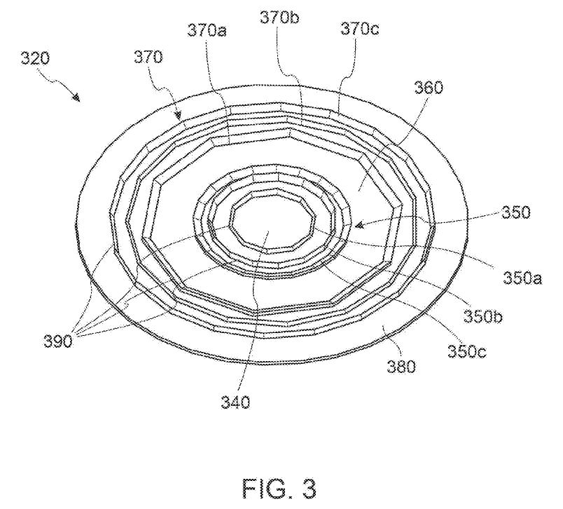

A third example lens according to the present disclosure has an optic zone 320 (FIG. 3). The optic zone 320 comprises a central zone 340 having a base power (selected to correct the distance vision of a wearer of the lens) and a treatment zone formed from concentric annular regions, namely a first annular region 350, a second annular region 360, a third annular region 370 and a fourth annular region 380. The second and fourth annular regions 360, 380 have the base power and are free from optical prisms. The first annular region 350 includes three concentric rings 350a,b,c having the shape of regular polygons. The third annular region 370 also includes three concentric rings 370a,b,c having the shape of regular polygons. The polygonal rings are separated by regions of base power. The edges of each polygonal ring 350a-c, 370a-c are each formed from an optical prism 390. The number of edges (and hence the number of prisms 390), the prism angle (which determines the size of the shift introduced into the image, i.e. the prism power), and the width of the prisms 390 (which determine the amount of light – i.e. the intensity of light - in the respective shifted image) in each polygonal ring 350a-c, 370a-c is different for each successive polygonal ring 350a-c, 370a-c.

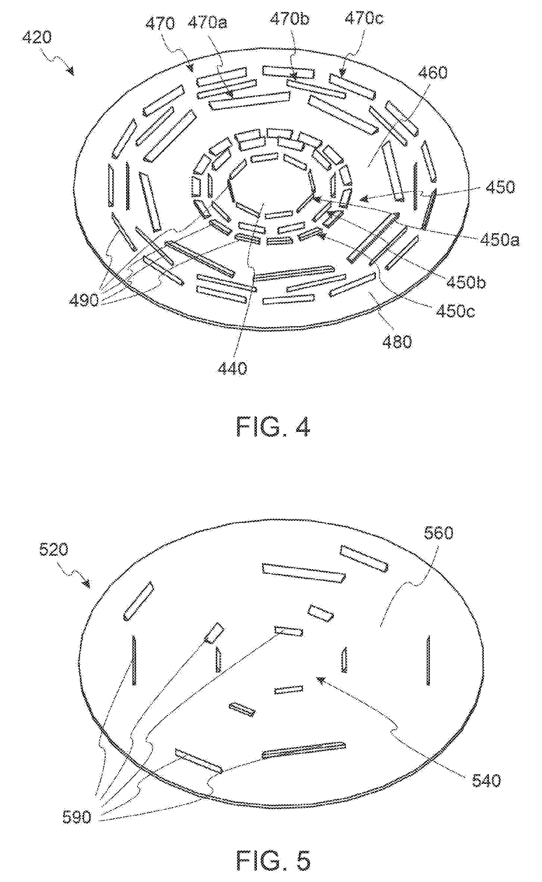

A fourth example lens according to the present disclosure has an optic zone 420 (FIG. 4). The optic zone 420 comprises a central zone 440 having a base power (selected to correct the distance vision of a wearer of the lens) and a treatment zone formed from concentric annular regions, namely a first annular region 450, a second annular region 460, a third annular region 470 and a fourth annular region 480. The second and fourth annular regions 460, 480 have the base power and are free from optical prisms. The first annular regions 450 includes three concentric broken rings 450a,b,c, with each broken ring having overall the shape of a regular polygon. The third annular region 470 also includes three concentric broken rings 470a,b,c having the shape of regular polygons. The polygonal rings are separated by regions of base power. The edges of each polygonal ring 450a-c, 470a-c are each formed from an optical prism 490. The number of edges (and hence the number of prisms 490), the prism angle, and the width of the prisms 490 in each polygonal ring 450a-c, 470a-c is different for each successive polygonal ring 450a-c, 470a-c. The optical prisms 490 within each ring 450a-c, 470a-c have the same length as each other (i.e. the lengths of the edges of any given polygonal ring 450a-c, 470a-c are the same as each other) but those lengths are different in different polygonal rings 450a-c, 470a-c. The optical prisms 490 are discrete and separate from each other, i.e. they are discontinuous in the broken rings 450a-c, 470a-c.

A fifth example lens according to the present disclosure has an optic zone 520 (FIG. 5). The optic zone 520 comprises a central zone 540 having a base power (selected to correct the distance vision of a wearer of the lens) and free from optical prisms. The optic zone 520 also has a treatment zone including a plurality of optical prisms 590, separated by regions 560 that have the base power. The optical prisms 590 are discrete and separate from each other and they are different from each other, having different prism angles, widths and lengths. The locations of the optical prisms 590 are irregular within the treatment zone, avoiding the creation of a ring-shaped image at the retina.

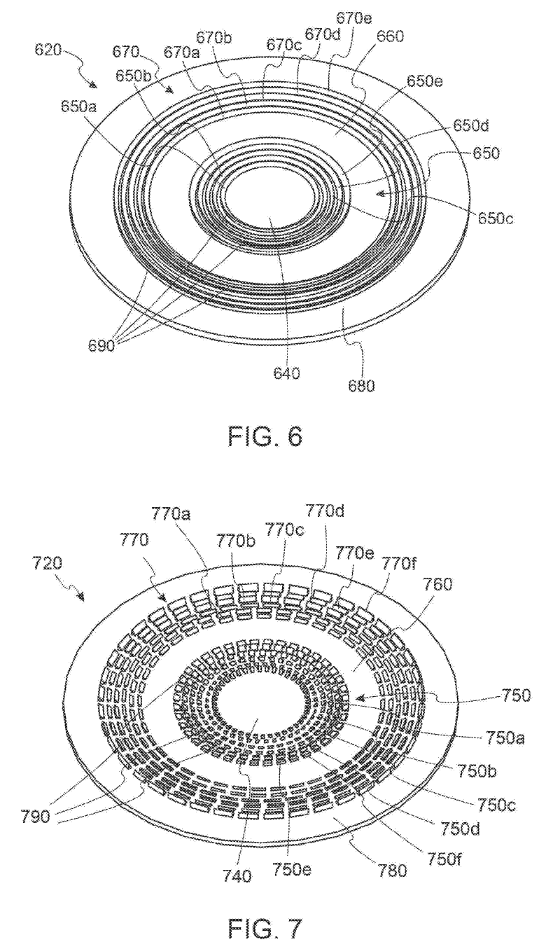

A sixth example lens according to the present disclosure has an optic zone 620 (FIG. 6). The optic zone 620 comprises a central zone 640 having a base power (selected to correct the distance vision of a wearer of the lens) and a treatment zone formed from concentric annular regions, namely a first annular region 650, a second annular region 660, a third annular region 670 and a fourth annular region 680. The second and fourth annular regions 660, 680 have the base power and are free from optical prisms. The first annular regions 650 includes five concentric circular rings 650a-e. The third annular region 670 also includes five concentric circular rings 670a-e. The circular rings are separated by regions of base power. Each circular ring 650a-e, 670a-e is formed of a circular optical prism 690, i.e. each optical prism 690 is an annulus. The prism angle and the width of the prism 690 forming each circular ring 650a-e, 670a-e is different for each successive circular ring 650a-e, 670a-e.

A seventh example lens according to the present disclosure has an optic zone 720 (FIG. 7). The optic zone 720 comprises a central zone 740 having a base power (selected to correct the distance vision of a wearer of the lens) and a treatment zone formed from concentric annular regions, namely a first annular region 750, a second annular region 760, a third annular region 770 and a fourth annular region 780. The second and fourth annular regions 760, 780 have the base power and are free from optical prisms. The first annular regions 750 includes six concentric broken circular rings 750a-f. The third annular region 770 also includes six concentric broken circular rings 770a-f. The circular rings are separated by regions of base power. Each circular ring 750a-f, 770a-f is formed from a plurality of arcuate optical prisms 790. The number of prisms 790, the prism angle, and the width of the prisms 790 in each circular ring 750a-f, 770a-f is different for each successive circular ring 750a-f, 770a-f. The optical prisms 790 within each ring 750a-f, 770a-f have the same curved length as each other but those lengths are different in different circular rings 750a-f, 770a-f. The optical prisms 790 are discrete and separate from each other, i.e. they are discontinuous in the broken rings 750a-f, 770a-f.

Light from a distant, on-axis point source will not be imaged to a single spot by the optic zones of the first to seventh example lenses discussed above. Rather, a point source will be imaged to a more complex pattern, corresponding to the pattern, determined by the number, location, size, shape and tilts of prisms in the optic zone. A straight optical prism having the base power of the lens will image a point source to a point that is displaced from the image point produced by regions (including the central region) that have the base power. On the other hand, a curved optical prism having the base power of the lens will image a point source to a point spread function that is itself a line or a curve. In more detail, if the prism is not curved each ray passing through it will be deviated in the same direction and thus, at the image plane, a point spread function of focused light will be created, not a line. The point spread function will be a line when the prism orientation changes along the prism extent, i.e. the prism is curved. Each point along a curved prism can be considered to be a separate prism, each with a different orientation, directing adjacent rays to different locations.

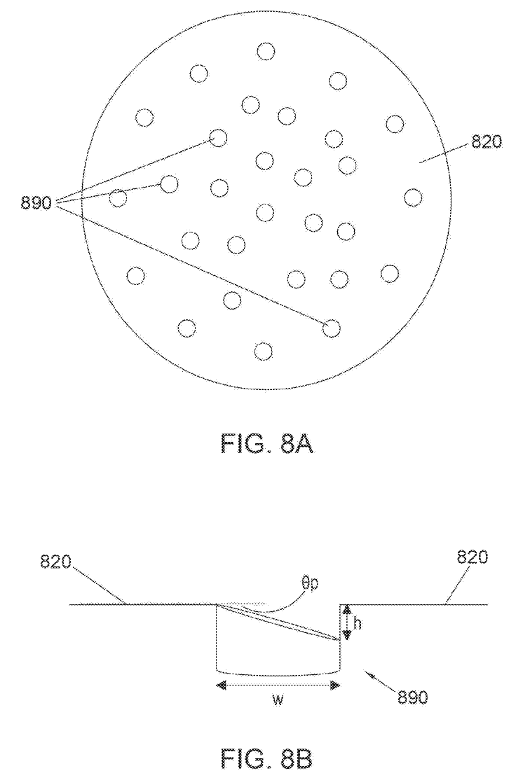

FIG. 8A illustrates schematically an example arrangement of optical prisms within a pupil-sized area of a spectacle lens and in this example includes a plurality of discrete, circular optical prisms 890 distributed across the area. Each optical prism 890 occupies a localised region of the pupil-sized area and is configured to introduce a local prism angle relative to adjacent prism-free regions 820 within the pupil-sized area. The optical prisms 890 differ from one another in orientation and/or prism angle such that images formed by light passing through different optical prisms are displaced in different directions within the focal plane. The prism-free regions 820 form a matrix surrounding the prisms 890.

FIG. 8B illustrates schematically a cross-section through a single circular optical prism 890. The optical prism 890 is formed by a local tilt of the lens surface relative to an adjacent prism-free region 820 of the optic zone. In this example, the tilt is into the body of the spectacle lens, so that the optical prism forms a depression in the surface of the spectacle lens. The prism angle θp represents the surface tilt relative to the surrounding surface introduced by the optical prism. The optical prism 890 has a width w and a maximum height (depth) h. The height (depth) of the optical prism 890 changes linearly across its surface. Light passing through the optical prism 890 is therefore deviated laterally without introducing additional converging or diverging power, such that an image formed by rays passing through the optical prism is focused and laterally displaced within the focal plane relative to an image formed by rays passing through the prism-free region 820.

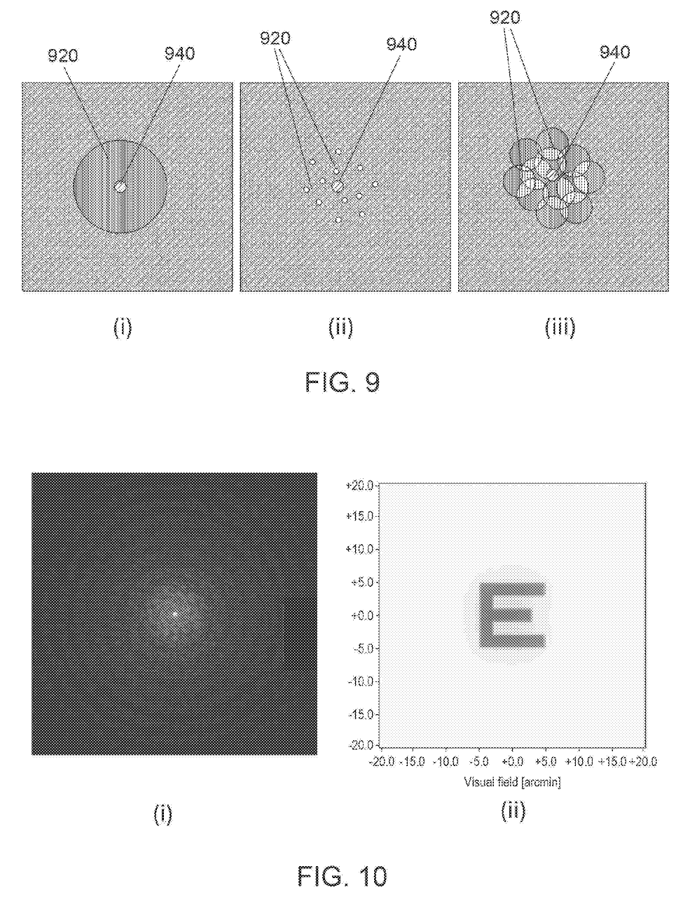

As illustrated by FIGS. 8A and 8B, the finite width w of each optical prism 890 results in a limited effective aperture for light passing through that prism. Consequently, images formed by individual optical prisms are subject to diffraction effects in addition to the lateral displacement introduced by the prism angle θp, resulting in the formation of a composite point spread function. FIG. 9 illustrates schematically the formation of a composite image from a plurality of image components generated by microprisms. FIG. 9(i) shows a primary focused image 940 together with a target blur size 920. The primary focused image 940 corresponds to light passing through prism-free regions of the optic zone and forming an image at the base power focal plane. The target blur size 920 indicates a region of the focal plane over which it is desired to distribute light as a result of contributions from additional image components formed by the microprisms.

FIG. 9(ii) shows a geometrical optics representation of the same optic, in which the composite image comprises the primary focused image 940 together with a plurality of individually displaced images 920 formed by respective microprisms. In this representation, each of the displaced images 920 is focused in the geometrical optics sense but is laterally displaced within the focal plane relative to the primary focused image 940 due to the prismatic deviation introduced by the corresponding microprism.

FIG. 9(iii) shows a wave-optics representation of the same optic as was used to generate the geometrical optics representation of FIG. 9(ii). In this representation, each of the individually displaced images 920 exhibits a finite spatial extent as a result of diffraction. The superposition of the primary focused image 940 and the plurality of displaced diffraction-blurred images 920 results in a composite image that extends over a region of the focal plane corresponding approximately to the target blur size 920 shown in FIG. 9(i).

FIG. 10 shows a wave-optics modelled point spread function of another spectacle lens according to the present disclosure. FIG. 10(i) is the diffraction structure of the point spread function corresponding to light passing through the lens. FIG. 10(ii) is an example image formed by the same optic, demonstrating the effect of the composite point spread function on image formation. As shown, the resulting image exhibits reduced contrast (the original object was a 100% contrast letter) as a consequence of the superposition of the primary image component and the plurality of laterally displaced, diffraction-blurred image components formed by the microprisms, consistent with the wave-optics representation.

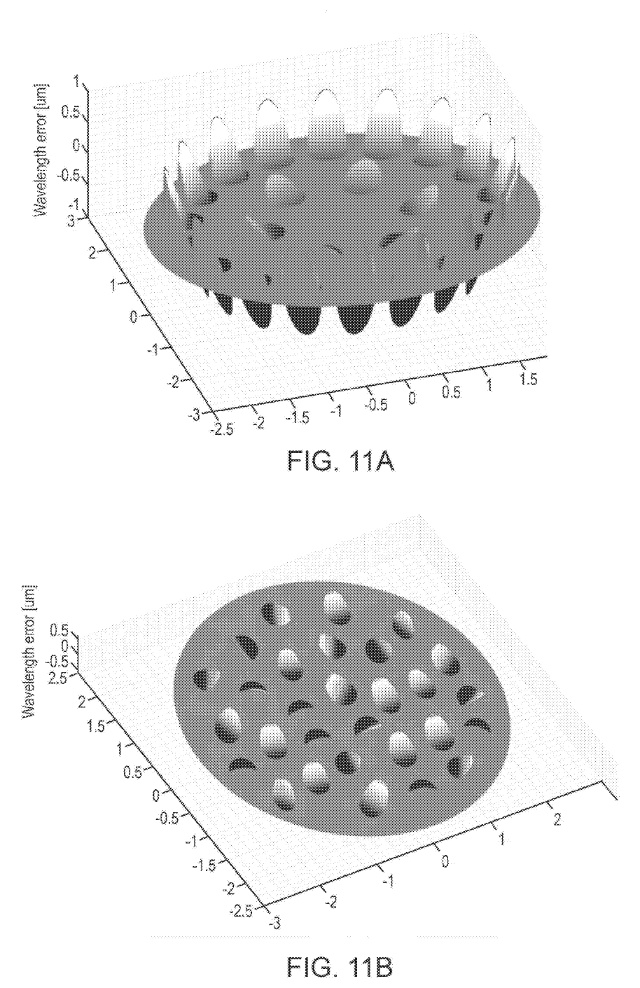

FIG. 11A illustrates a plot of wavefront error as a function of position on the lens across an example 5 mm diameter pupil for an array of optical prisms that are arranged to displace rays radially away from the centre of the lens. In this arrangement, the orientations of the optical prisms are coordinated such that the prismatic deviation introduced by each prism is directed substantially along a radial direction. As shown, the wavefront error exhibits a structured and radially symmetric pattern across the optic zone, reflecting the fact that rays passing through different prism locations are deviated in directions that are correlated with their radial position on the lens.

FIG. 11B illustrates a plot of wavefront error as a function of position on the lens across an example 5 mm diameter pupil for an array of optical prisms that are arranged to displace rays at random deviation angles. In this arrangement, the orientations of the optical prisms vary such that the directions of ray deviation are not radially aligned but instead differ between prisms. As shown, the resulting wavefront error pattern lacks radial symmetry as in FIG. 11A, reflecting the variation in prism orientation across the example pupil within the lens optic zone.

FIGS. 11A and 11B therefore illustrate two different example configurations of optical prism arrays that may be used to generate laterally displaced images. In each case, the wavefront error plots represent the local tilts introduced by the optical prisms across the lens surface, which give rise to laterally displaced image components in the focal plane as described above. The arrangements differ in the manner in which the directions of ray deviation vary across the optic zone, while both remaining consistent with the generation of multiple displaced image components that contribute to a composite point spread function.

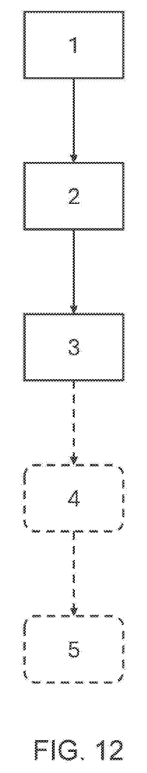

In an example method (FIG. 12) of manufacturing an ophthalmic lens according to the present disclosure a first mould half and a second mould half are formed (STEP 1). A lens precursor material is provided (STEP 2) between the first mould half and the second mould half. The precursor material is cured (STEP 3) to form the ophthalmic lens. At least one of the first mould half and the second mould half includes a region shaped to form an optic zone in the finished lens. The optic zone comprises a region having a base power for correcting distance vision. The optic zone comprises a treatment zone. The treatment zone includes a plurality of optical prisms. The plurality of optical prisms includes at least two optical prisms that differ from each other in prism power, prism angle or prism orientation. In an optional further step, where the ophthalmic lens is a contact lens, the contact lens is hydrated (STEP 4). In a further optional step, the contact lens is packaged (STEP 5).

Spectacle lenses are commonly produced from a lens blank that is subsequently processed to provide the required optical prescription. In many commercial manufacturing processes, the starting lens material is an organic polymer (for example a thermosetting resin or a thermoplastic reason) rather than mineral glass, which was widely used in the past. In an example manufacturing process, the polymer lens is formed by casting a curable liquid composition, such as a monomer or monomer mixture, into a mould cavity corresponding to a desired preliminary lens geometry. The cast composition is then polymerised and cured to produce a transparent lens blank. Depending on the manufacturing route, the blank may be a finished stock lens or, more commonly for prescription applications, a semi-finished lens blank having one surface preformed and an opposite surface left available for subsequent machining.

The blank may then be subjected to surfacing in order to generate the optical prescription on at least one lens surface. In a typical process, the unfinished surface of a semi-finished blank is machined to form a surface profile corresponding to the required refractive power. The surfacing operation may include grinding and polishing steps. The surface profile including the optical prisms may be produced by for example computer-controlled or freeform machining, laser engraving or diamond turning, or a coating composition may be applied to at least one surface of the substrate and may be shaped before curing, for example by stamping. The resulting lens can then proceed to subsequent finishing operations such as coating, edging, and mounting.

It will be appreciated by those of ordinary skill in the art that features of the example embodiments may be combined in other embodiments that fall within the scope of the present disclosure.

Whilst in the foregoing description, integers or elements are mentioned which have known obvious or foreseeable equivalents, then such equivalents are herein incorporated as if individually set forth. Reference should be made to the claims for determining the true scope of the present disclosure, which should be construed as to encompass any such equivalents. It will also be appreciated by the reader that integers or features of the disclosure that are described as advantageous, convenient or the like are optional, and do not limit the scope of the independent claims. Moreover, it is to be understood that such optional integers or features, whilst of possible benefit in some embodiments of the disclosure, may not be desirable and may therefore be absent in other embodiments.

What is claimed is:

1-21. (canceled)

22. An ophthalmic lens comprising an optic zone, the optic zone comprising:
(i) at least one region having a base power for correcting distance vision; and
(ii) a treatment zone including a plurality of optical prisms,
wherein the plurality of optical prisms (a) have the base power and (b) include at least two optical prisms that differ from each other in prism power, prism angle or prism orientation.

23. The ophthalmic lens as claimed in claim 22, wherein the plurality of optical prisms includes at least two optical prisms that differ from each other in width.

24. The ophthalmic lens as claimed in claim 22, wherein the optic zone includes a central zone having the base power.

25. The ophthalmic lens as claimed in claim 24, wherein the treatment zone includes at least one treatment region that contains a plurality of the prisms and surrounds the central zone.

26. The ophthalmic lens as claimed in claim 25, further comprising at least one base-power region that has the base power and surrounds the treatment region.

27. The ophthalmic lens as claimed in claim 22, wherein the plurality of optical prisms forms a plurality of rings.

28. The ophthalmic lens as claimed in claim 27, wherein at least one of the prisms is annular.

29. The ophthalmic lens as claimed in claim 27, wherein at least one of the rings is a discontinuous circle, formed from two or more of the optical prisms each separated from the other.

30. The ophthalmic lens as claimed in claim 27, wherein at least one of the rings is polygonal.

31. The ophthalmic lens as claimed in claim 30, wherein each prism within the polygonal ring joins with a neighbouring prism within the polygonal ring so that the polygonal ring is continuous.

32. The ophthalmic lens as claimed in claim 30, wherein at least one of the rings is a discontinuous polygon, formed from two or more of the optical prisms each separated from the other.

33. The ophthalmic lens as claimed in claim 30, wherein the number of vertices in the polygon is different for each polygon.

34. The ophthalmic lens as claimed in claim 22, wherein at least one of the prisms is disc-shaped.

35. The ophthalmic lens as claimed in claim 22, wherein the optical prisms are positioned irregularly within the optic zone.

36. The ophthalmic lens as claimed in claim 22, wherein at least one of the prism base length, base width and angle are different from each optical prism to optical prism.

37. An ophthalmic lens having a lens body with a front surface and a back surface, the front surface meeting the back surface at an edge but otherwise being separated from the back surface at every point in the lens body by a distance, the front surface having a first shape and the back surface having a second shape, the first shape and the second shape together defining in the lens body:
(i) a plurality of features, wherein said distance changes within each of the features such that the feature is an optical prism, wherein said change in distance in at least one of the features is different from said change in distance in at least one other of the features; and
(ii) a region of the lens body that is free from said features and wherein said distance changes with radial distance such that the region is a converging or diverging lens region for correcting the distance vision of a wearer’s eye.

38. An ophthalmic lens comprising an optic zone, the optic zone comprising: (i) a distance vision region having a base power for correcting distance vision; and (ii) a treatment zone including a plurality of optical prisms having the base power, wherein the plurality of optical prisms includes at least two optical prisms that differ from each other in the angle at which they tilt relative to adjacent prism-free surface regions of the lens.
